(19) United States
(12) Patent Application Publication
(10) Pub. No.: US 2012/0244251 A1
(43) Pub. Date: Sep. 27, 2012

(54) METHOD OF PRODUCING BREAD USING FINAL PROOFED FROZEN DOUGH AND METHOD OF PRODUCING THE FINAL PROOFED FROZEN DOUGH

(75) Inventors: Ryuji UEMURA, Tokyo (JP); Masashi YOSHIDA, Tokyo (JP)

(73) Assignee: NISSHIN FLOUR MILLING INC., Tokyo (JP)

(21) Appl. No.: 13/397,746

(22) Filed: Feb. 16, 2012

(30) Foreign Application Priority Data
Mar. 22, 2011 (JP) 2011-062258

(51) Int. Cl. A21D 8/04

(52) U.S. Cl. 426/20; 426/19

(57) ABSTRACT

Producing a bread by a straight method of directly baking a frozen dough for breads that has undergone final proofing. A specific volume of the frozen dough for breads that has undergone the final proofing immediately before baking falls within a range of 1.3 to 2.1 cm³/g.

### TECHNICAL FIELD

The present invention relates to a method of producing bread, and more particularly, to a method of producing bread, which directly bakes frozen dough having a specific volume controlled to be as small as possible to obtain breads having a large volume, a good appearance, and a favorable taste and texture, and melting easily in the mouth. Further, the invention relates to a method of producing final proofed frozen dough for bread which is for use in the method of producing bread.

### BACKGROUND ART

For example, when producing bread using a straight method, the method generally includes preparing a dough by kneading all bread-making raw materials such as wheat flour, yeast, and water, and then sequentially performing first fermentation, splitting and rounding, leaving the dough for Bench time if necessary, molding, final proofing (second fermentation), and baking, thereby producing bread. Since a long time is required to perform a series of processes of producing bread in the related art, there are cases that frozen bread dough or refrigerated bread dough is used to streamline the producing process.

When the bread dough is frozen, if the dough is frozen after final proofing, it is advantageous in that the effort and labor required for the process between producing dough and obtaining baked bread may be saved. However, a problem is arisen in that since the dough frozen after molding and final proofing (fermentation) is large in volume, a huge freezing space is required during the course of distribution or storage which is very costly. Moreover, a volume, an appearance, and a texture of the obtained bread is not good.

Patent literature 1 proposes a method of producing bread dough frozen after final proofing which does not require huge storage and transporting spaces and allows production of baked bread having a good appearance, texture, and flavor. According to the method, the bread dough is obtained at 22 to 27° C., and is then sequentially divided, molded, coated with butter as a coating agent on the surface thereof, subjected to final proofing at 22 to 27° C., and frozen. The bread dough frozen after final proofing described in patent literature 1 has a small specific volume, thereby resulting in a reduction in storage and transporting spaces. However, the bread obtained according to the technique disclosed in patent literature 1 is not yet satisfactory in terms of a volume, an appearance, and a texture.

Patent literature 2 proposes a method of refrigerating bread dough which includes maintaining the fermented bread dough at a temperature of 5 to 20° C. for 2 to 6 hours and refrigerating the bread dough at a temperature of 1 to 4° C. for 5 to 15 hours. However, patent literature 2 does not disclose a specific volume of the bread dough. In patent literature 2, in the case of Examples 1 and 2 according to a straight method, since it takes a long time to perform first fermentation, the obtained bread dough may have a large specific volume.

Further, patent literature 3 proposes a method of producing bread having a characteristic appearance, flavor, and taste. The method includes fermenting dough under a condition of 0 to 18° C. for 6 to 22 hours. However, patent literature 3 does not disclose a specific volume of the bread dough. Further, in the method of producing the bread described in patent literature 3, since the fermentation is performed at low temperatures (0 to 18° C.) for a long period of time (6 to 22 hours), the obtained bread may not yet be satisfactory in terms of a volume, an appearance, and a texture.

Meanwhile, a conditioning agent for bread is known to be used to obtain bread having various characteristics such as a sufficient volume, a favorable texture, and easy melting in the mouth. Patent literature 4 discloses a conditioning agent for bread including an enzyme including α-amylase and xylanase, thickening polysaccharides including pectin and a guar gum, and an L-ascorbic acid. Patent literature 5 discloses a conditioning agent for bread which includes a combination of an enzyme including α-amylase and hemicellulase, gums, and an L-ascorbic acid.

### CITATION LIST

### Patent Literature

Patent literature 1: US 2006292268 A1
Patent literature 2: Japanese Patent No. 2775019
Patent literature 3: Japanese Patent No. 4231312
Patent literature 4: JP 2005-261221 A
Patent literature 5: US 2004091601 A1

### SUMMARY OF INVENTION

### Technical Problem

An object of the present invention is to provide a method of producing bread having a large volume, a good appearance, and a favorable taste and texture, and melting easily in the mouth by using frozen dough having a small specific volume.

### Solution to Problem

In order to achieve the above object, according to the invention, there is provided a method of producing a bread by a straight method of baking a frozen dough for breads that has undergone final proofing, including: controlling a specific volume of the frozen dough for breads that has undergone the final proofing immediately before baking to fall within a range of 1.3 to 2.1 cm³/g.

Further, there is provided a method of producing a frozen dough for breads which has undergone final proofing used in the method of producing the bread described above, including: adding an enzyme including α-amylase and xylanase, thickening polysaccharide including pectin and an alginic acid, and an L-ascorbic acid to cereal powder including wheat flour for breads as a main ingredient; adding water; performing kneading to form the dough for breads at a dough temperature of 16 to 22° C., performing, after the dough for breads is subjected to first fermentation at 4 to 30° C. for 5 to 10 minutes, divided, and molded, the final proofing at 12 to 20° C. for 15 to 180 minutes; controlling a specific volume of the dough for breads that has undergone the final proofing to a range of 1.3 to 2.1 cm³/g; and performing freezing.

### Advantageous Effects of Invention

According to a method of producing bread of the invention, since frozen dough having a specific volume controlled to be small is used, a huge freezing space is not required during a distribution process or storage, and the cost for making bread may be reduced. Further, since known dough frozen after fermentation of final proofing has a large specific volume, the dough easily thaws during a distribution process or storage, which impairs the quality of the thawing portion of the dough. However, according to the method of producing bread of the invention, since frozen dough having a specific volume controlled to be small is used, this problem does not occur, and breads having a large volume, a good appearance, and a favorable taste and texture, and melting easily in the mouth can be obtained.

Further, in the method of producing bread of the invention, when frozen dough obtained using the method of producing final proofed frozen dough for breads of the invention is used, a significant effect of obtaining breads having a large volume, a good appearance, and a favorable taste and texture, and easily melting in the mouth can be obtained.

### DESCRIPTION OF EMBODIMENTS

Hereinafter, a method of producing bread according to the invention is described in detail with reference to exemplary embodiments.

The method of producing bread according to the invention includes controlling a specific volume of a final proofed frozen dough for bread immediately before baking to be in a range of 1.3 to 2.1 cm³/g and preferably in a range of 1.7 to 1.9 cm³/g. When the specific volume of the final proofed frozen dough for bread immediately before the baking is less than 1.3 cm³/g or more than 2.1 cm³/g, bread having a large volume, a good appearance, and a favorable taste and texture, and melting easily in the mouth may not be obtained. Moreover, when the specific volume is more than 2.1 cm³/g, a freezing space during a distribution process or storage cannot be reduced by a sufficient amount.

In addition, in a typical method of producing bread, the specific volume of a dough for bread which has undergone final proofing and is ready for baking is about 2.4 to 2.5 cm³/g.

In the method of producing bread according to exemplary embodiments of the invention, known raw materials may be appropriately selected as bread-making raw materials depending on the kind of target breads. Generally the bread-making raw materials include a main ingredient such as cereal powders including wheat flour for breads (preferably 70% by weight or more based on whole cereal powders), and auxiliary ingredients such as water, yeast, yeast foods, saccharides, table salts, fats and fatty oils, eggs, and dairy products.

Hard flour is typically used as wheat flour for breads, but alternatively other wheat flour such as durum wheat flour, all purpose flour, and soft flour may be used. Further, wheat flour for breads may be used in conjunction with rye flour, rice flour, corn flour, buckwheat flour, or starches as cereal powders.

In the method of producing bread of the invention, it is preferable that the enzyme including α-amylase and xylanase, thickening polysaccharides including pectin and the alginic acid, and the L-ascorbic acid are added as the auxiliary ingredients to cereal powders including wheat flour for breads as the main ingredient, water is added to the cereal powders, those are kneaded to form dough. Accordingly, a significant effect of producing breads having a large volume, a good appearance, and a favorable taste and texture, and easily melting in the mouth can be obtained.

Commercial enzyme preparations may be used as α-amylase and xylanase that are the enzyme. It is preferable that the amount of α-amylase used be 5×10⁻⁶ to 1×10⁻⁴ parts by mass and particularly 1.5×10⁻⁵ to 5.0×10⁻³ parts by mass based on 100 parts by mass of cereal powders including wheat flour for breads as the main ingredient. It is preferable that the amount of xylanase used be 1×10⁻⁵ to 2×10⁻⁴ parts by mass and particularly 0.5×10⁻⁴ to 2.0×10⁻⁴ parts by mass based on 100 parts by mass of cereal powders including wheat flour for breads as the main agent.

Any one of HM pectin and LM pectin may be used as pectin that are thickening polysaccharides. It is preferable that the amount of pectin used be 0.1 to 10 parts by mass and particularly 0.5 to 5.0 parts by mass based on 100 parts by mass of cereal powders including wheat flour for breads as the main ingredient. Further, it is preferable that the amount of alginic acid used be 0.001 to 0.5 parts by mass and particularly 0.005 to 0.1 parts by mass based on 100 parts by mass of cereal powders including wheat flour for breads as the main ingredient.

It is preferable that the amount of L-ascorbic acid used be 1.0×10⁻³ to 2.0×10⁻² parts by mass and particularly 5.0×10⁻³ to 1.5×10⁻² parts by mass based on 100 parts by mass of cereal powders including wheat flour for breads as the main ingredient.

In addition, the amount of water used may be appropriately selected depending on the kind of target breads.

The method of producing bread of the invention is a bread-making method based on a straight bread-making method. When the method of producing bread of the invention is applied to other bread-making methods other than the straight method, for example, a sponge method, the effect of the invention cannot be exhibited. In the method of producing bread of the invention, process up to final proofing are performed in accordance with the known straight method. Typically, all bread-making raw materials are kneaded to form dough for breads, first fermentation is performed, splitting and rounding are performed, Bench time is provided if necessary, molding is performed, and final proofing (second fermentation) is performed.

A preferable bread-making condition is described below to implement a significant effect of the invention.

When all bread-making raw materials are kneaded to form dough for breads, it is preferable that dough for breads is formed at a dough temperature of 16 to 22° C. The dough temperature may be controlled by a typical method. It is preferable that the subsequent first fermentation be performed at 4 to 30° C. and particularly 18 to 30° C. for 5 to 10 minutes.

Further, it is preferable that the final proofing be performed at 12 to 20° C. for 15 to 180 minutes. The period of the final proofing is appropriately selected depending on the temperature. Desirably, in the case of 12° C., the range of 30 to 180 minutes is preferable, and in the case of 20° C., the range of 15 to 45 minutes is preferable. It is preferable that the final proofing be performed at a relative humidity of 80 to 95%.

In addition, the final proofing temperature of 12 to 20° C. according to the present embodiment is lower than a final proofing temperature of a typical bread-making. In the typical bread-making, the final proofing is performed at about 28 to 40° C. for about 40 to 80 minutes to sufficiently increase the volume of breads.

The particularly preferable bread-making condition of the invention is as follows.

The enzyme including α-amylase and xylanase, thickening polysaccharides including pectin and the alginic acid, and the L-ascorbic acid are added to cereal powders including wheat flour for breads as the main ingredient, water is added, and kneading is performed to form dough for breads at the dough temperature of 16 to 22° C., the dough for breads is subjected to the first fermentation at 4 to 30° C. for 5 to 10 minutes, divided, and molded, and the final proofing is performed at 12 to 20° C. for 15 to 180 minutes.

In the method of producing bread of the invention, the dough for breads which has undergone the final proofing is required to be frozen to be used as frozen dough and the specific volume of the frozen dough for breads which has undergone the final proofing immediately before baking is controlled to be in a range of 1.3 to 2.1 cm³/g.

An example of a method of controlling the specific volume of the frozen dough for breads which has undergone the final proofing to the range of 1.3 to 2.1 cm³/g may include a process of appropriately selecting a temperature and a time for final proofing and a process of performing the final proofing to set the specific volume to the range of 1.3 to 2.1 cm³/g. In this case, the dough for breads which has undergone the final proofing may be frozen as it is. Typically, the specific volume of the dough for breads which has undergone the final proofing does not change over freezing.

Another example of a method of controlling the specific volume of the frozen dough for breads which has undergone the final proofing to the range of 1.3 to 2.1 cm³/g may include a process of pressing dough for breads which has undergone final proofing to set the specific volume to the range of 1.3 to 2.1 cm³/g and a process of freezing the dough. This method is preferable for breads using fold-fats, such as croissants and Danish pastries. It is preferable that the specific volume of the dough for breads which has undergone the final proofing but not yet undergone pressing be 1.7 to 2.4 cm³/g. Further, it is preferable that the specific volume after the pressing be in the range of 80 to 100% of the specific volume before the pressing.

It is preferable that the pressing is uniformly performed, and the pressing may be accomplished by using a press having press plates at upper and lower sides thereof or passing dough between a pair of rotating rollers.

In a case where uniform pressing is performed by using the press having the press plates at the upper and the lower sides thereof, the uniform pressure is applied to the upper and lower sides of the dough for breads when the specific volume reaches 1.7 to 2.4 cm³/g by the final proofing so that the dough for breads would have a desired height (preferably 8 to 15 mm) in a uniformly pressed state. In this way, the flat dough for breads which has undergone the final proofing may be obtained.

In a case where a pair of rotating rollers is used, the dough may be passed between the pair of rotating rollers at an interval controlled to be a desired width (preferably 8 to 15 mm) when the specific volume reaches 1.7 to 2.4 cm³/g by the final proofing to obtain the flat dough for breads which has undergone the final proofing.

It is preferable that the height of the dough for breads which has undergone the final proofing after the pressing be 11 to 12 mm. In addition, since the height of the dough for breads which has undergone the final proofing is slightly recovered by elasticity of the dough while pressure for the pressing is released compared to a state where the dough is put under pressure, the height in a uniformly pressed state or the interval between the rotating rollers is appropriately selected in consideration of this.

When the dough for breads which has undergone the final proofing and thus has the specific volume controlled to be in the range of 1.3 to 2.1 cm³/g is frozen as it is, frozen dough for breads which has undergone the final proofing and has the specific volume controlled to be in the range of 1.3 to 2.1 cm³/g may be obtained. The freezing may be performed by a typical method, and rapid freezing is preferable. The obtained frozen dough for breads which has undergone the final proofing is distributed and stored in a frozen state.

In the method of producing bread of the invention, the frozen dough for breads which has undergone the final proofing is baked as it is, rather than baked after thawing, to obtain breads. If the frozen dough is baked after thawing, breads that are favorable in terms of volume, appearance, and texture cannot be obtained. It is preferable that a bake temperature be appropriately selected from a range of 180 to 210° C. and particularly 185 to 195° C., and a bake time be appropriately selected from a range of 21 to 33 minutes and particularly 24 to 30 minutes, depending on the kind or the size of breads.

The kind of breads produced by the method of producing bread of the invention is not particularly limited, but examples may include plain breads, sweet buns, Danish pastries, French breads, croissants, hard rolls, semihard rolls, butter rolls, and Brioches, and among these, semihard roll, croissant, and Danish pastries are very suitable.

### EXAMPLES

The invention will now be shown in detail with reference to Examples. It should be understood, nevertheless, that the scope of the invention is not limited thereto.

Details of the enzyme, thickening polysaccharides and the like used in the following Examples and the like are as follows.

α-amylase: trade name: SPITASE XP-404, manufactured by Nagase & Co., Ltd.

Xylanase: trade name: CELLULASE XL-531, manufactured by Nagase & Co., Ltd.

Pectin (HM pectin): trade name: GENU BIG-J, manufactured by CP Kelco-Japan Company

Alginic acid: trade name: ALGINIC ACID NF, manufactured by KIMICA Corporation

L-ascorbic acid: trade name: C-50, manufactured by Kongo Medicine Co., Ltd.

In the following Examples and the like, the weight, the volume, the height, and the specific volume of the dough for breads and the volume of the breads after baking were measured by using the specific volume measuring equipment (Model No.: Win VM2000, manufactured by ASTEX Research & Development Co., Ltd., Measurement mode: 2 CCD precision measurement). In addition, the specific volume measuring equipment is specifically described in Japanese Patent Application Publication (JP-B) No. 7-6772.

### Examples 1 and 2 and Comparative Example 1

### Producing of the Semihard Roll

The semihard roll was produced by the following compounding and producing method of the dough for semihard rolls.

TABLE 1
(Compounding of dough for semihard rolls)

| Compounding raw material | Compounding amount (parts by weight) |
|---|---|
| Hard flour* | 100 |
| L-ascorbic acid | 0.01 |
| α-amylase | 2 × 10⁻⁵ |
| Xylanase | 1.2 × 10⁻⁴ |
| HM pectin | 1.0 |
| Alginic acid | 0.1 |
| Yeast for frozen dough | 1.5 |
| Table salt | 1.8 |
| Sugar | 3 |
| Nonfat dry milk | 2 |
| Whole egg | 3 |
| Shortening | 4 |
| Water | 63 |

*trade name: CAMELLIA, manufactured by Nisshin Flour Milling Inc.

### (Producing Method)

In Examples 1 and 2 and Comparative example 1, water and all compounding raw materials other than shortening were added to hard flour, all of them were mixed, water was added, kneading was performed at a low rate for 5 minutes and, subsequently, at a middle rate for 5 minutes, shortening was added, and kneading was performed at a middle rate for 14 minutes to form dough for semihard rolls (dough temperature at kneading: 20 to 22° C.).

Subsequently, the obtained dough for semihard rolls was subjected to first fermentation at 20° C. for 10 minutes and then divided into pieces, each having an amount of 80 g, and the Bench time at 20° C. for 25 minutes was provided. Subsequently, molding was performed by using the mold to form the roll dough having the length of 22 cm, and the final proofing (relative humidity of 90%, and see Table 2 with respect to the temperature and the time) was performed. Subsequently, water was sprayed on the surface of the dough, the surface was cut by the Coop knife, and rapid freezing was performed at −40° C. for 30 minutes to obtain frozen dough for semihard rolls which had undergone the final proofing.

The frozen dough for semihard rolls which had undergone the final proofing did not thaw but was baked as it was in the oven at 190° C. for 27 minutes to obtain the semihard roll.

### Comparative Example 2

### Producing of the Semihard Roll (Known Product)

The semihard roll was produced by the following producing method and the same compounding as in Example 1, except that the enzyme (α-amylase and xylanase) and thickening polysaccharides (HM pectin and the alginic acid) were not used.

### (Producing Method)

After the molding was performed by using the same procedure as in Example 1 to form the roll dough, the rapid freezing was performed at −40° C. for 30 minutes to obtain the molded frozen dough for semihard rolls, which was not subjected to the final proofing. The molded frozen dough for semihard rolls was stored at −20° C., thawed at 18° C. for 30 minutes, and subjected to the final proofing (32° C., for 60 minutes, and relative humidity of 90%). Subsequently, water was sprayed on the surface of the dough, the surface was cut by the Coop knife, and the dough was baked in the oven at 210° C. for 20 minutes to obtain the semihard roll.

When producing the semihard rolls of Examples 1 and 2 and Comparative examples 1 and 2, the weight, the volume, the height, and the specific volume of the dough after the final proofing (after cutting was performed by the Coop knife) were measured. In Examples 1 and 2 and Comparative example 1, the specific volume of even the frozen dough immediately before the baking was measured. The results are presented in Table 2.

Further, the volumes of the semihard rolls obtained in Examples 1 and 2 and Comparative examples 1 and 2 were measured. The results are presented in Table 2. Furthermore, the appearance and the texture of the obtained semihard roll were evaluated by ten panels according to the evaluation standard described in the following Table 3. The average points of the evaluation results are presented in Table 2.

TABLE 2

| | | | | | | | Specific | | | |
|---|---|---|---|---|---|---|---|---|---|---|
| | | | | | | | volume of | | | |
| | | | Dough after final proofing | | | | frozen dough | | | |
| | final proofing | | | | | Specific | immediately | Product evaluation | | |
| | Time | Temperature | Weight | Volume | Height | volume | before baking | Volume | Appearance | Texture |
| | (min) | (° C.) | (g) | (cc) | (mm) | (cm³/g) | (cm³/g) | (cc) | (point) | (point) |
| Example 1 | 30 | 20 | 80 | 136 | 26 | 1.7 | 1.7 | 439 | 4.8 | 4.2 |
| Example 2 | 45 | 20 | 80 | 168 | 26 | 2.1 | 2.1 | 454 | 5.0 | 4.3 |
| Comparative | 0 | 20 | 80 | 96 | 20 | 1.2 | 1.2 | 311 | 2.2 | 2.1 |
| example 1 | | | | | | | | | | |
| Comparative | 60 | 32 | 80 | 216 | 33 | 2.7 | * | 402 | 3.0 | 3.0 |
| example 2 | | | | | | | | | | |

* In Comparative example 2, since the dough is frozen before the final proofing, and directly baked as it is after the final proofing, the specific volume of the frozen dough immediately before baking was not measured.

TABLE 3
Evaluation standard;

| | | |
|---|---|---|
| Appearance | 5 points | Coop largely grown in the kiln is largely split, |
| | | and back color is uniform golden brown. |
| | 4 points | Coop grown in the kiln is split, and back color is |
| | | almost uniform light golden brown. |
| | 3 points | Coop exiguously grown in the kiln is split, and |
| | | the bake color is slightly dark but there are a |
| | | few spots. |
| | 2 points | Coop hardly grown in the kiln is slightly split, |
| | | and the bake color is slightly light but there are |
| | | spots. |
| | 1 point | A split of coop not grown in the kiln is not |
| | | opened, and the bake color is light and there are |
| | | spots. |
| Texture | 5 points | Very good chewing texture, glutinous, and easy |
| | | melting in the mouth. |
| | 4 points | Good chewing texture, slightly glutinous, and |
| | | slightly easy melting in the mouth. |
| | 3 points | Slightly good chewing texture, slightly glutinous, |
| | | and slightly easy melting in the mouth. |
| | 2 points | Slightly sticky, slightly cumbersome, and slightly |
| | | poorly melting in the mouth. |
| | 1 point | Sticky, cumbersome, and poorly melting in the |
| | | mouth. |

### Examples 3 to 5

### Producing of the Croissant

The croissant was produced by the following compounding and producing method of the dough for croissants.

TABLE 4
(Compounding of the dough for croissant)

| Compounding raw material | Compounding amount (parts by mass) |
|---|---|
| Hard flour* | 100 |
| L-ascorbic acid | 0.01 |
| α-amylase | 6 × 10⁻⁵ |
| Xylanase | 1 × 10⁻⁴ |
| HM pectin | 0.8 |
| Alginic acid | 0.2 |
| Yeast for frozen dough | 3 |
| Table salt | 1.8 |
| Sugar | 6 |
| Nonfat dry milk | 1 |
| Whole egg | 10 |
| Margarine | 2 |
| Water | 48 |

*trade name: SOLE D'OR, Nisshin Flour Milling Inc.

### (Producing Method)

All compounding raw materials other than water and fold-fats were added to hard flour, water was added, and kneading was performed at a low rate for 5 minutes to form dough for croissants (dough temperature at kneading: 16 to 18° C.).

Subsequently, the obtained dough for croissants was subjected to first fermentation at 24° C. for 10 minutes, largely split, and refrigerated at −5° C. for 2 hours. Subsequently, triple folding was performed two times by using 50 parts by weight of the fold-fats, refrigerating was performed at −5° C. for 1 hour, triple folding was performed once, and refrigerating was performed at −5° C. for 1 hour. Subsequently, the dough was cut in each amount of 60 g to form the final dough having a thickness of 2.8 mm and a size of 11 cm×18 cm, and the final dough was molded into croissants.

Subsequently, after the final proofing (20° C., relative humidity of 90%, and see Table 5 with respect to the time) was performed, the dough was passed between a pair of rotating rollers at an interval controlled to be 10 mm to perform pressing. The egg liquid was applied onto the surface of the dough after the pressing and then rapidly frozen at −40° C. for 30 minutes to obtain frozen dough for croissants subjected to the final proofing.

The frozen dough for croissants subjected to the final proofing did not thaw and was baked as it was in the oven at 190° C. for 25 minutes to obtain the croissant.

### Comparative Example 3

### Producing of the Croissant (Known Product)

The croissant was produced using the following producing method and the same compounding as in Example 3, except that the enzyme (α-amylase and xylanase) and thickening polysaccharides (HM pectin and the alginic acid) were not used.

### (Producing Method)

After the molding was performed to form the croissant by using the same procedure as in Example 3, the rapid freezing was performed at −40° C. for 30 minutes to obtain the molded frozen dough for croissants, which has not been subjected to the final proofing. The molded frozen dough for croissants was stored at −20° C., and then thawed at 18° C. for 30 minutes. Subsequently, the final proofing (32° C., for 70 minutes, and relative humidity of 80%) was performed, and egg liquid was applied onto the surface of the dough, and the dough was baked in the oven at 210° C. for 14 minutes to obtain the croissant.

When producing the croissants of Examples 3 to 5, the weight, the volume, the height, and the specific volume of the dough before and after the pressing, and the specific volume of the frozen dough immediately before the baking were measured. Further, when producing the croissant of Comparative example 3, the weight, the volume, the height, and the specific volume of the dough immediately before the baking was measured. The results are presented in Table 5.

The volumes of the croissants obtained in Examples 3 to 5 and Comparative example 3 were measured. The measurement results are presented in Table 5. Furthermore, the appearance and the texture of the obtained croissant were evaluated by ten panels according to the evaluation standard described in the following Table 6. The average points of the evaluation results are presented in Table 5.

TABLE 5

| | | | | | | | | | | | | Specific | | | |
|---|---|---|---|---|---|---|---|---|---|---|---|---|---|---|---|
| | | | | | | | Press | | | | | volume | | | |
| | | | | | | | thick- | | | | | of frozen | | | |
| | Final | | | | | | ness | | | | | dough | | | |
| | proofing | | | | | | (gap | | | | | imme- | | | |
| | | Tem- | Dough before pressing | | | | between | Dough after pressing | | | | diately | Product evaluation | | |
| | | pera- | | Vol- | | Specific | rotating | | Vol- | | Specific | before | | Appear- | |
| | Time | ture | Weight | ume | Height | volume | rollers) | Weight | ume | Height | volume | baking | Volume | ance | Texture |
| | (min) | (° C.) | (g) | (cc) | (mm) | (cm³/g) | (mm) | (g) | (cc) | (mm) | (cm³/g) | (cm³/g) | (cc) | (point) | (point) |
| Example 3 | 15 | 20 | 45 | 77 | 33 | 1.7 | 10 | 45 | 63 | 12 | 1.4 | 1.4 | 278 | 4.7 | 4.0 |
| Example 4 | 30 | 20 | 45 | 85 | 35 | 1.9 | 10 | 45 | 77 | 11 | 1.7 | 1.7 | 286 | 5.0 | 4.9 |
| Example 5 | 45 | 20 | 45 | 108 | 36 | 2.4 | 10 | 45 | 72 | 10 | 1.6 | 1.6 | 294 | 4.9 | 4.2 |
| Comparative | 70 | 32 | 45 | 118 | 41 | 2.6 | * | * | * | * | * | * | 244 | 3.0 | 3.0 |
| example 3 | | | | | | | | | | | | | | | |

* In Comparative example 3, since the dough is frozen before the final proofing and is then baked as it is without pressing after the final proofing, data of the dough after pressing and the specific volume of the frozen dough immediately before baking were not measured.

TABLE 6
Evaluation standard;

| | | |
|---|---|---|
| Appearance | 5 points | Good-shaped layer largely grown in the kiln is |
| | | observed, and bake color is uniform golden |
| | | brown. |
| | 4 points | Layer grown in the kiln is observed, and bake |
| | | color is almost uniform light golden brown. |
| | 3 points | Layer exiguously grown in the kiln is observed, |
| | | and the bake color is slightly dark but there are a |
| | | few spots. |
| | 2 points | Layer slightly grown in the kiln is observed, and |
| | | the bake color is slightly light but there are spots. |
| | 1 point | Layer grown in the kiln is not observed at all, and |
| | | the bake color is light and there are spots. |
| Texture | 5 points | Very crunchy, good chewing texture, and very |
| | | easy melting in the mouth. |
| | 4 points | Crunchy, almost good chewing texture, and |
| | | almost easy melting in the mouth. |
| | 3 points | Slightly crunchy, slightly chewing texture, and |
| | | slightly easy melting in the mouth. |
| | 2 points | Weakly crunchy, slightly poor chewing texture, |
| | | and slightly poorly melting in the mouth. |
| | 1 point | Not crunchy, poor chewing texture, and poorly |
| | | melting in the mouth. |

1. A method of producing a bread by a straight method of baking a frozen dough for breads that has undergone final proofing, comprising:
controlling a specific volume of the frozen dough for breads that has undergone the final proofing immediately before baking to fall within a range of 1.3 to 2.1 cm³/g.

2. A method of producing a frozen dough for breads which has undergone final proofing used in the method of producing the bread according to claim 1, comprising:
adding an enzyme including α-amylase and xylanase, thickening polysaccharide including pectin and an alginic acid, and an L-ascorbic acid to cereal powder including wheat flour for breads as a main ingredient;
adding water;
performing kneading to form the dough for breads at a dough temperature of 16 to 22° C.;
performing, after the dough for breads is subjected to first fermentation at 4 to 30° C. for 5 to 10 minutes, divided, and molded, the final proofing at 12 to 20° C. for 15 to 180 minutes;
controlling a specific volume of the dough for breads that has undergone the final proofing to a range of 1.3 to 2.1 cm³/g; and
performing freezing.
